(19) United States
(12) Patent Application Publication
(10) Pub. No.: US 2018/0106466 A1
(43) Pub. Date: Apr. 19, 2018

(54) Simply Mounted Lamp and Lamp Replacement Device

(71) Applicant: K.SCIENCE LIMITED, Kowloon, Hong Kong (CN)

(72) Inventor: Kam Kwan CHAN, Kowloon, Hong Kong (CN)

(21) Appl. No.: 15/567,368

(22) PCT Filed: May 26, 2016
(86) PCT No.: PCT/CN2016/083415

§ 371 Date: Oct. 17, 2017

(30) Foreign Application Priority Data
Jun. 5, 2015 (CN) 201520386541.2

(51) Int. Cl. F21V 19/04; F21V 19/00; F21S 8/04

(52) U.S. Cl. CPC F21V 19/04; F21V 19/0015; F21V 11/06; F21S 8/04; F21V 19/003

(57) ABSTRACT

A lighting apparatus for simple installation and replacement device thereof is provided. The lighting apparatus includes a light source and a fixing device, wherein the light source is installed on the fixing device and the fixing device is compatible with the current mounting base for the current fluorescent lamps, so that the light source can be mounted on the current mounting base without the need to modify or reconstruct the current mounting base so as to install the lighting apparatus in a convenient manner

### BACKGROUND OF THE PRESENT INVENTION

### Field of Invention

The present invention relates to a field of lighting device, and more particularly to an apparatus for simply installation and replacement device thereof, wherein the lighting apparatus is capable of replacing the current fluorescent lamps, and is adapted to be simply installed on the current mounting base adapted for mounting the current fluorescent lamps.

### DESCRIPTION OF RELATED ARTS

Since Edison invented the first incandescent lamp, working and living hours for all humans are expanded to daytime to nighttime, so that some areas which couldn't be explored during the nighttime can be explored, accompanied by different kinds of lighting devices being developed and produced.

Different kinds of lighting device have different lighting theories, and different kinds of lighting effect are provided by different kinds of lighting device. The performance of the power consumption is also different. The performance of the incandescent lamp is replaced by the fluorescent lamp which can be widely used in houses, offices, and different areas.

The replacement of a lighting device is not only based on the structure of the lighting device, but also is required to be incorporated with a mounting base. For example, the traditional lighting device installed is the incandescent lamp, and the mounting base is pre-designed for the incandescent lamp correspondingly, so that if the incandescent lamp would like to be replaced by the fluorescent lamp, the circuit components, such as ballast and starters, of the fluorescent lamp are not applicable with the mounting base, and thus the fluorescent lamp cannot be directly mounted on the mounting base. Accordingly, an improved fluorescent lamp having compatible circuit components for the current mounting base is provided to install on the current mounting base.

Accordingly, it is known that procedures for replacing one lighting device to another lighting device are complicated. The fluorescent lamp is not a preferred optical lighting device, and still has lot drawbacks. It means that there is another requirement and demand of replacing the fluorescent lamp.

Based on the improvement of the society, more and more people are focused on energy saving and environment protection issues. Electric energy is a base energy for human beings, so an energy saving lighting device is required to improve human life. LED lighting device is the current preferred substitution provided to replace the conventional fluorescent and incandescent lamps. Comparing with the fluorescent and incandescent lamps, LED lighting device is an energy saving device and has longer life-span. However, how to replace the fluorescent and incandescent lamps with the LED lighting devices conveniently and cost effectively becomes the difficulty to be resolved.

As mentioned above, the replacement of a lighting device is not only based on the structure of the lighting device, but also is relevant to the circuit components of the lighting device. For examples, the modification of the circuits and the installation positions of the lighting device are required to be incorporated. Referring to FIG. 1 of the drawings, a current fluorescent lamp is illustrated.

In order to install the fluorescent lamp, a mounting base 100P is provided and compatible with the shape, such as length and width, of the fluorescent lamp. During remodeling a house, the mounting base 100P is required to be pre-formed. In other words, if another lighting apparatus is required to replace the fluorescent lamp, the mounting base 100P is required to be remodeled that huge amount of manpower would be consumed. For example, if the fluorescent lamp, as shown in FIG. 1, is replaced by the LED lighting device, the mounting base 100P is required to be remodeled according to the structure of the specific kind of the current LED lighting device. Therefore, most of the people select to refuse to replace the fluorescent lamp due to the complicated replacing procedures in term of the short term economic consideration.

In order to obtain the best illumination effect, the fluorescent lamp comprises a grid member 200P and, especially, when the fluorescent lamp is installed on the mounting base, the grid member 200P is able to provide a reflection effect in order to enhance the strength of the illumination and improve the usage of the illumination. The grid member 200P is predesigned to incorporate with the mounting base 100P, so the grid member 200P will be thrown away while the fluorescent lamp is replaced by the LED lighting. It is not economic to dispose the grid member 200P and also requires to solve problems of the installation of the current LED lighting device, so that it is not convenient and practical to directly replace and install the LEDs.

The fluorescent lamp general requires to be equipped with a base circuit 300P and related circuit components inside the mounting base 100P, such as ballast and starter. Therefore, the circuit of the fluorescent lamp generally includes the ballast and starters while the LED lighting device does not require such circuit components, so that during the replacement of the fluorescent lamp, the existing circuit for the fluorescent lamp must be modified since the current LED lighting device is not adapted to be equipped with the existing circuit directly.

Furthermore, if the replaced LED lighting device could not incorporate with the mounting base 100P of the original fluorescent lamp, even though the LED lighting device is replaced, the LED lighting device and the mounting base 100P are not match and adversely affect the ornamental appearance thereof.

In addition, in modern life, more and more instruments are provided to facilitate people's lives, such as audio devices, projectors and etc., that these instruments are able to enrich people's lives, but also required much storing and placing spaces. According to the relatively higher real property price in modern life, living spaces are especially important to families with smaller apartments. People are required to select either the ambulance living life or the limited living space, or otherwise, due to the limitation of the living space, it is preferred not to purchase too many instruments. There always has a great demand in space saving solution.

### SUMMARY OF THE PRESENT INVENTION

The invention is advantageous in that it provides a lighting apparatus for simple installation and replacement device thereof, wherein the lighting apparatus is adapted to be simply mounted on a mounting base of the current lighting fixture so as to replace the current fluorescent lamps without involving any complicated installation procedure.

Another advantage of the invention is to provide a lighting apparatus for simple installation and replacement device thereof, wherein the lighting apparatus is adapted to utilize the existing mounting base and the installation position for the current fluorescent lamps without the need to replace or modify the original mounting base of the fluorescent lamps.

Another advantage of the invention is to provide a lighting apparatus for simple installation and replacement device thereof, wherein the lighting apparatus can be incorporated with the existing mounting base for the fluorescent lamp, so as to maintain the integral and beautiful appearance of the existing mounting base.

Another advantage of the invention is to provide a lighting apparatus for simple installation and replacement device thereof, wherein the lighting apparatus is able to be electrically connected to the existing circuit for the fluorescent lamp without the need to replace or modify the existing circuit for the current fluorescent lamp.

Another advantage of the invention is to provide a lighting apparatus for simple installation and replacement device thereof, wherein the grid member for the current fluorescent lamp can be used with the present invention, so as to prevent a waste of resources during the replacement of the fluorescent lamps with the lighting apparatus of the present invention.

Another advantage of the invention is to provide a lighting apparatus for simple installation and replacement device thereof, wherein the lighting apparatus can be directly mounted on a bottom portion of the grid member without detaching the existing grid member so as to further simplify the installation process.

Another advantage of the invention is to provide a lighting apparatus for simple installation and replacement device thereof, wherein the installation of the lighting apparatus is simple without involving any complicated procedure and requiring any professional replacement or installation technician, so that it is adapted for mass replacement of the fluorescent lamps.

Another advantage of the invention is to provide a lighting apparatus for simple installation and replacement device thereof, wherein LED lights are used in the lighting apparatus to replace the current fluorescent lamps, so as to save more electrical energy.

Another advantage of the invention is to provide a lighting apparatus for simple installation and replacement device thereof wherein the grid member for the current fluorescent lamp can be used as a fixing member to affix the lighting apparatus, so as to prevent the incompatible problems between the lighting apparatus and the mounting base.

Another advantage of the invention is to provide a lighting apparatus for simple installation and replacement device thereof, wherein the lighting apparatus comprises a fixing member which is affixed on the mounting base for the current fluorescent lamp, and at the same time, it is easy to obtain electric power for the LED light from the original circuit.

Another advantage of the invention is to provide a lighting apparatus for simple installation and replacement device thereof, wherein the lighting apparatus is able to be directly mounted on the original grid member and install components of the grid member without disassembling the original grid member, so as to provide a more convenient installation method.

Another advantage of the invention is to provide a lighting apparatus for simple installation and replacement device thereof, wherein the lighting apparatus can be mounted on a position where the mounting base is located or to be hanged below the grid member, so the lighting apparatus can be simply installed without affecting its original integral and ornamental appearance.

Another advantage of the invention is to provide a lighting apparatus for simple installation and replacement device thereof, wherein the replacement device of the lighting apparatus is capable of replacing the existing lighting devices, so that the existing installation space and location as well as the existing circuit can be utilized.

Another advantage of the invention is to provide a lighting apparatus for simple installation and replacement device thereof, wherein the replacement device of the lighting apparatus comprises a replacing member arranged on a fixing member, wherein the replacing member is a projecting member adapted to perform projecting function.

Another advantage of the invention is to provide a lighting apparatus for simple installation and replacement device thereof wherein the replacing member is an audio device for playing music.

Another advantage of the invention is to provide a lighting apparatus for simple installation and replacement device thereof, wherein the replacing member is an intelligent control member which is able to perform intelligent control.

Additional advantages and features of the invention will become apparent from the description which follows, and may be realized by means of the instrumentalities and combinations particular point out in the appended claims.

According to the present invention, the foregoing and other objects and advantages are attained by a lighting apparatus, which comprises a light source and a fixing device, wherein the light source is mounted on the fixing device, and the fixing device is compatible with the current mounting base, so that the light source is adapted to be mounted on the current mounting base.

Preferably, the fixing device of the lighting apparatus comprises a main frame, and an illumination surface of the light source is adapted to downwardly face and install on the main frame.

Preferably, the fixing device of the lighting apparatus comprises at least one frame connecting member provided on the main frame, so that the frame connecting member is matched with the base connecting member of the mounting base, and thus the main frame can be supported inside the mounting base.

Preferably, the frame connecting member of the lighting apparatus further has a connecting groove, wherein the connecting groove and a connecting arm of the base connecting member are matched with each other, so that the connecting arm can be inserted into the connecting groove.

Preferably, the fixing device of the lighting apparatus comprises four frame connecting members arranged adjacent four corners of the main frame and are connected with the connecting arms of the base connecting members correspondingly.

Preferably, the lighting apparatus comprises a circuit unit electrically connected with the light source.

Preferably, the light source of the lighting apparatus is a LED lighting device.

Preferably, the fixing device of the lighting apparatus is a grid member.

Preferably, the circuit unit of the lighting apparatus is arranged inside the light source.

Preferably, the circuit member of the lighting apparatus comprises an input end having a plurality of terminals adapted to be electrically connected to the base circuit.

Preferably, the circuit member of the lighting apparatus comprises an input end and an output end, wherein the input end is adapted to be electrically connected to the base circuit, and the output end is adapted to be electrically connected to the light source.

Preferably, the circuit member is provided on the fixing device of the lighting apparatus adapted to connect to a bottom portion of the grid member.

Preferably, the fixing device of the lighting apparatus is a frame connecting member which is connected to a bottom portion of the grid member.

Preferably, the frame connecting member of the lighting apparatus is a hanging member adapted for hanging to the bottom portion of the grid member.

Preferably, the hanging member is a hanger.

Preferably, the frame connecting members of the lighting apparatus comprises four hanging members arranged adjacent to four corners of the main frame.

In accordance with another aspect of the invention, the present invention provides a replacement device adapted to be simply installed on the mounting base for the current fluorescent lamp, wherein the mounting base comprises a base circuit and a grid member. The replacement device comprises a replacing member and a fixing device. The replacing member is adapted to be installed on the fixing device which is matched with the mounting base, so that the light source is adapted to be installed on the current mounting base.

Preferably, the fixing device of the replacement device comprises a main frame, and the replacing member is arranged on the main frame to provide a position for the replacing member.

Preferably, the fixing device of the replacement device comprises at least a frame connecting member arranged on the main frame, and the frame connecting member is compatible with the base connecting member of the mounting base, so that the main frame is able to be supported in the mounting base.

Preferably, the frame connecting member of the lighting apparatus has a connecting groove which is matched with the connecting arm of the base connecting member, so that the connecting arm is able to be inserted into the connecting groove.

Preferably, the fixing device of the lighting apparatus comprises four frame connecting members arranged adjacent to four corners of the main frame respectively, wherein the four frame connecting members are matched with the connecting arms of the four base connecting members.

Preferably, the lighting apparatus comprises a circuit member electrically connected to the replacing member.

Preferably, the replacing member of the replacement device is a projecting member which is electrically connected to the circuit member to perform projecting function.

Preferably, the replacing member of the replacement device is an audio electrically connected to the circuit member for playing music.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded view of a current fluorescent lamp, illustrating the installation situation for the current fluorescent lamp.

FIG. 2A and FIG. 2B are perspective views of a lighting apparatus according to a first preferred embodiment of the present invention.

FIG. 3 is an exploded view of the lighting apparatus according to the above mentioned preferred embodiment of the present invention.

FIG. 4 is a perspective view of the lighting apparatus according to the above mentioned preferred embodiment of the present invention, illustrating the installation of the lighting apparatus.

FIG. 5 is a perspective view of the lighting apparatus according to the above mentioned preferred embodiment of the present invention, illustrating the manufacturing process of the lighting apparatus.

FIG. 6A and FIG. 6B are perspective views of a lighting apparatus according to a second preferred embodiment of the present invention.

FIG. 7 is an exploded view of the lighting apparatus according to the above mentioned second preferred embodiment of the present invention.

FIG. 8 is a perspective view of the lighting apparatus according to the above mentioned second preferred embodiment of the present invention, illustrating the installation of the lighting apparatus.

FIG. 9 is perspective views of a lighting apparatus according to a third preferred embodiment of the present invention.

FIG. 10 is an exploded view of the lighting apparatus according to the above mentioned third preferred embodiment of the present invention.

FIG. 11 is a perspective view of the lighting apparatus according to the above mentioned third preferred embodiment of the present invention, illustrating the installation of the lighting apparatus.

FIG. 12 and FIG. 13 are perspective views of a replacement device according to a fourth preferred embodiment of the present invention.

FIG. 14 and FIG. 15 are perspective views of a replacement device according to a fifth preferred embodiment of the present invention.

FIG. 16 and FIG. 17 are perspective views of a replacement device according to a sixth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

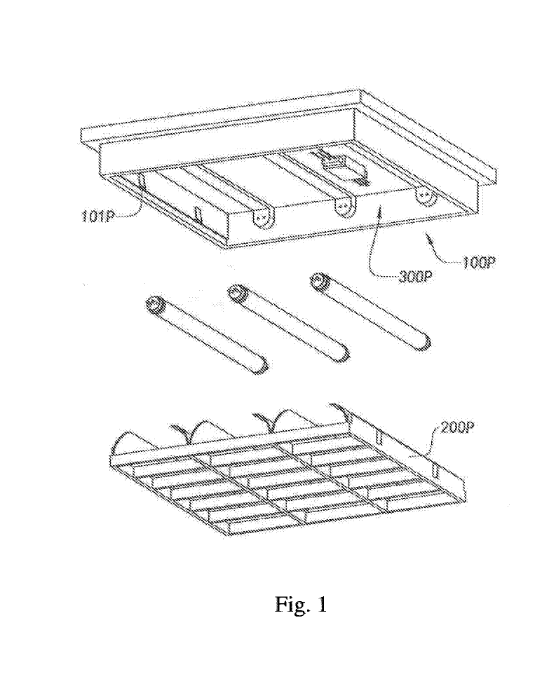

Referring to FIG. 1 of the drawings, a general installing method of the current fluorescent lamp is illustrated. Fluorescent lamps are popular everywhere in our daily life, and most of the fluorescent lamps are installed by the installing method as shown in FIG. 1. The broad range of the usage of the fluorescent lamps and the differences between the fluorescent lamp and the LED lights render the replacement of fluorescent lamps with the LED lights a large and cumbersome task. How to simply replace the fluorescent lamps with LED lights while utilizing the current mounting base 100P, the grid member 200P, and the base circuit 300P of the fluorescent lamps and without the need to modify such current fundamental components so as to better save the electrical energy is the problem that the present invention can solve. Person who skilled in the art would understand that the main object of the present invention is to provide a solution to solve the problems of replacing the fluorescent lamps with LED lights but not limited to solve the problems in replacing the installing method of the current fluorescent lamps as shown in FIG. 1.

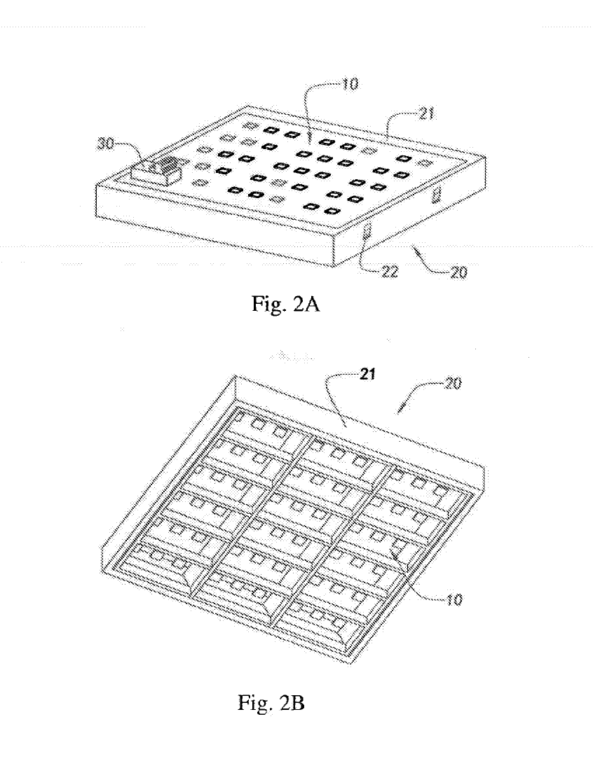

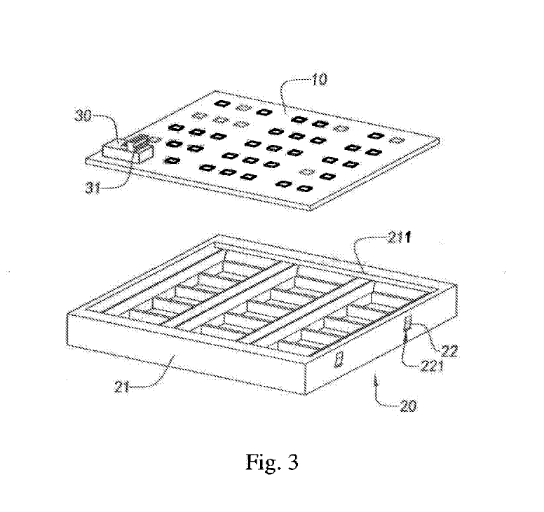

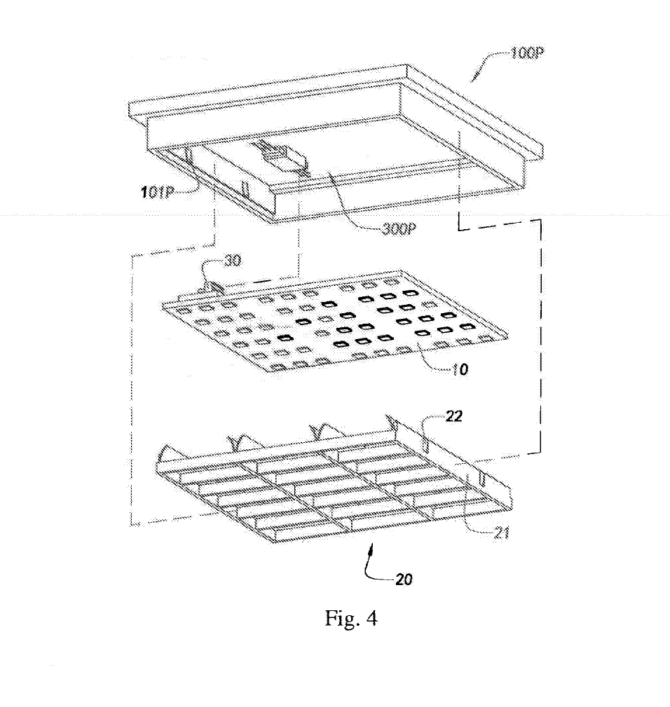

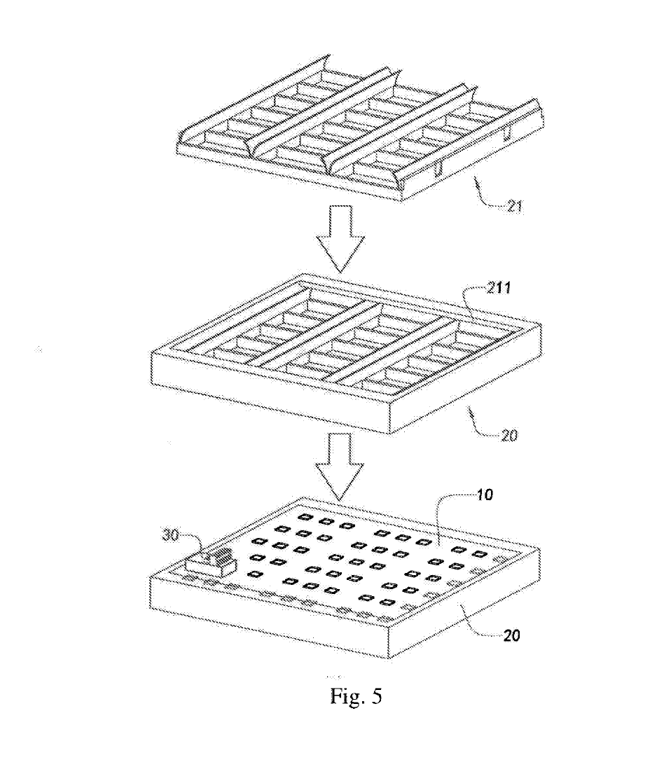

Referring to FIG. 2 to FIG. 5 of the drawings, a lighting apparatus according to a first preferred embodiment of the present invention is illustrated. The lighting apparatus is able to be installed on the mounting base 100P for the current fluorescent lamps. The lighting apparatus comprises a light source 10 and a fixing device 20, wherein the light source 10 is installed on the fixing device 20.

The fixing device 20 comprises at least a main frame 21 and at least a frame connecting member 22, wherein the frame connecting member 22 is arranged to be installed on the main frame 21 and the light source 10 is arranged to be installed on the main frame 21. The frame connecting member 22 is adapted to be connected with the mounting base 100P for the current fluorescent lamps, so that the lighting apparatus of the present invention can be directly installed on the current mounting base 100P. In other words, the fluorescent lamps can be replaced by the lighting apparatus of the present invention.

It is worth mentioning that the lighting apparatus is adapted to compatible with the mounting base 100P, so that the lighting apparatus can be appropriately installed on the mounting base 100P. In other words, after the grid member 200P is detached, the lighting apparatus is able to be directly installed on the mounting base 100P, so that it will not affect the overall visual effect and ornamental appearance of the location where the lighting apparatus installed.

The main frame 21 comprises a supporting platform 211 inwardly extended from the main frame 21 so that the light source 10 is adapted to be mounted thereon. In other words, the light source 10 is installed on the supporting platform 211 of the main frame 21. It is worth to mention that the light source 10 is downwardly installed on the supporting platform 211, so that the illuminating surface of the light source 10 would face downwardly while the lighting apparatus is mounted on the mounting base 100P.

Furthermore, the mounting base 100P comprises at least one base connecting member 101P incorporated with the base connecting member 101P. In other words, the frame connecting member 22 of the fixing device 20 is matched with the base connecting member 101P of the mounting base 100P, so that the lighting apparatus can be mounted on the mounting base 100P.

More particularly, the base connecting member 101P comprises a connecting arm upwardly extended and has a connecting groove 221 defined therein, wherein the connecting arm is inserted into the connecting groove 221 of the frame connecting member 22 to connect the main frame 21 and the mounting base 100P, so that the main frame 21 is able to be supported on the mounting base 100P.

Specifically, there are four base connecting members 101P arranged on positions adjacent to four corners of the mounting base 100P respectively. Correspondingly, the fixing device 20 comprises four frame connecting members 22 provided on positions adjacent to four corners of the main frame 21 respectively and arranged in respective to the base connecting member 101P of the mounting base 100P, so that the four base connecting members 101P are able to be inserted into the four frame connecting members 101P respectively, so as to stably install the lighting apparatus on the mounting base 100P.

It is worth mentioning that the shape of the frame connecting member 22 of the fixing device 20 is compatible with that of the base connecting member 101P of the mounting base 100P, so the lighting apparatus can be installed on the mounting base 100P. Therefore, person who skilled in the art would understand that the shape of the connecting groove 221 of the frame connecting members 22 is not limited by the above mentioned shape. For example, if the connecting groove 221 is formed on the mounting base 100P, the frame connecting member 2 can be formed as connecting wall or hangers. The frame connecting members 22 and the base connecting members 101P of the mounting base 100P can be incorporated with each other according to the substantial need of the mounting base.

The lighting apparatus further comprises a circuit member 30 electrically connected with the light source 10. The circuit member 30 is adapted to connect the base circuit 300P and the light source 10, so that the base circuit 300P is able to provide electric power to the circuit member 30 so as to provide electric power for the light source 10 to produce lights.

More particularly, the circuit member 30 comprises an input end 31 electrically connected to the base circuit 300P. The input end 31 comprises a plurality of circuit terminals electrically connected to the base circuit 300P of the mounting base 100P. For example, during the replacement installation of the fluorescent lamps, the circuit of the ballast is directly connected to the circuit terminals of the circuit end 31, so that the base circuit 300P is able to provide electric power to the light source 10A, without the need to modify or reconstruct the circuit of the original fluorescent lamps.

It is worth mentioning that the light source 10 of the present invention is preferred to include LED lights for replacement of the original fluorescent lamps for energy saving.

It is worth mentioning that the main frame 21 of the fixing device 20 can be a grid member to form a lamp plate 11 which is able to enhance the illuminating intensity of the light source 10 and the utilization of the light source 10. The shape of the lamp plate 11 is designed as strip shape according to the grid shape of the main frame 21, so that the lighting apparatus of the present invention is a LED grid lamp. In other words, the grid member 200P of the current fluorescent lamps provides the supporting platform 211 that enables the light source 10 to be installed on the grid member 200P.

During the installation of the lighting apparatus, the connecting groove 221 of the frame connecting member 22 is incorporated and engaged with the base connecting member 101P of the mounting base 100P so as to install the lighting apparatus on the mounting base 100P for the original fluorescent lamps, and that by electrically connecting the base circuit 300P of the light source 10 with the circuit member 30, the base circuit 300P obtains electric power, so that the lighting apparatus is able to be mounted on the mounting base 100P and performs normal illumination function.

It is worth mentioning that the grid member 200P of the current fluorescent lamp can be used to produce the lighting apparatus of the present invention during the producing process of the lighting apparatus, so as to enhance the utilization of resource and reduce the waste of resource.

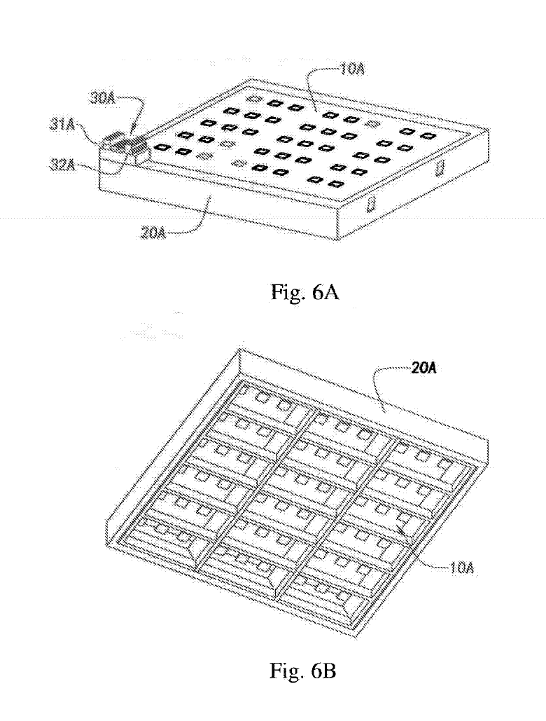

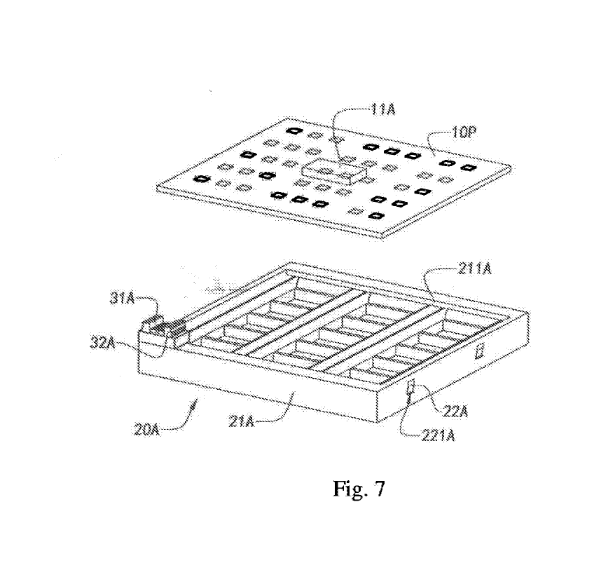

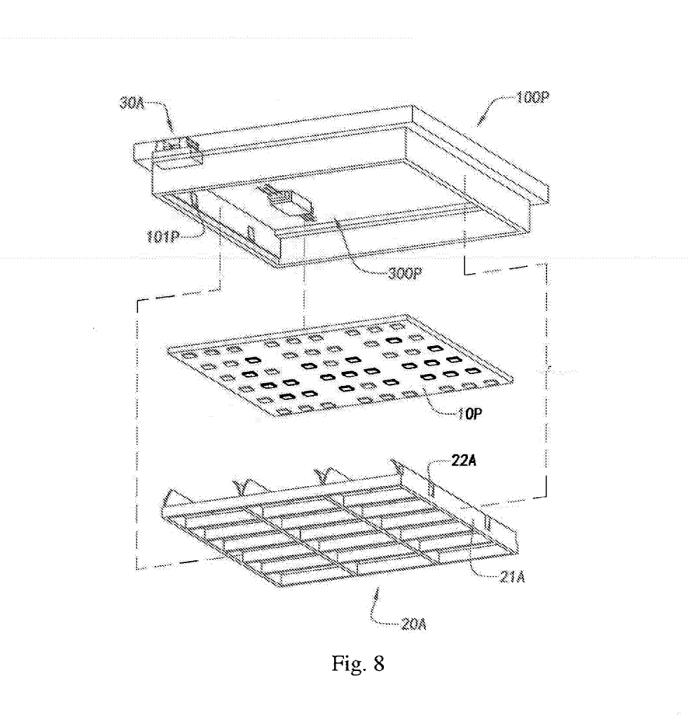

Referring to FIG. 6 to FIG. 8 of the drawings, a lighting apparatus according to a second preferred embodiment of the present invention is illustrated. The lighting apparatus is adapted to be installed on the mounting base 100P for the current fluorescent lamps. The lighting apparatus comprises a light source 10A and a fixing device 20A, wherein the light source 10A is mounted on the fixing device 20A.

The fixing device 20A comprises at least one main frame 21A and at least one connecting member 22A provided on the main frame 21A. The light source 10A is affixed on the main frame 21A. The frame connecting member 22A is adapted to be connected with the mounting base 100P for the current fluorescent lamp, so that the lighting apparatus of the present invention can be directly installed on the mounting base 100P. In other words, the fluorescent lamps can be replaced by the lighting apparatus for simple installation of the present invention.

It is worth mentioning that the lighting apparatus is adapted to be compatible with the mounting base 100P and can be appropriately installed on the mounting base 100P. In other words, after the grid member 300P is detached, the lighting apparatus is able to be directly received and installed in the space for the original mounting base 100P, so as to maintain the overall visual effect of the lighting apparatus.

The main frame 21A comprises a supporting platform 211A inwardly extended from the main frame 21A for installation of the light source 10A. In other words, the light source 10A is installed on the supporting platform 211A of the main frame 21A. It is worth mentioning that the light source 10A is downwardly installed on the supporting platform 211A, so that while the lighting apparatus is mounted on the mounting base 100P, an illuminating surface of the lighting source 10A faces downwardly.

Furthermore, the mounting base 100P comprises at least one base connecting member 101P, wherein the frame connecting member 22A is equipped with the base connecting member 101P. In other words, the frame connecting member 22A of the fixing device 20A is adapted to be matched with the base connecting member 101P of the mounting base 100P, so that the lighting apparatus is able to be mounted on the mounting base 100P.

More particularly, the base connecting member 101P is upwardly extended to form a connecting arm and the frame connecting member 22A comprises a connecting groove 221A, wherein the connecting arm is inserted into the frame connecting member 22A to connect the main frame 21A and the mounting base 100P, so that the main frame 21A is able to be supported on the mounting base 100P.

Specifically, the mounting base 100P comprises four base connecting members 101P arranged on positions adjacent to four corners of the mounting base 100P respectively. Correspondingly, the fixing device 20A comprises four frame connecting members 22A arranged on positions adjacent to four corners of the main frame 21A respectively, and that the four frame connecting members 22A are arranged on the positions respective to that of the base connecting member 101P, so that the four base connecting members 101P are adapted to be inserted into the four frame connecting members 101P respectively, so as to stably install the lighting apparatus on the mounting base 100P.

It is worth mentioning that the shape of the frame connecting member 22A of the fixing device 20 is compatible with that of the base connecting member 101P of the mounting base 100P, so that the lighting apparatus can be installed on the mounting base 100P. Therefore, the shape of the connecting groove of the frame connecting members 22A is not limited by above mentioned shapes. For example, if the connecting groove 221A is formed on the mounting base 100P, the frame connecting member 22A can be formed as connecting walls or hangers. The frame connecting members 22A and the base connecting member 101P of the mounting base 100P are incorporated with each other according to the need of the mounting base 100P.

The lighting apparatus further comprises a circuit member 30A provided on the main frame 21A. The circuit member 30 is adapted to be electrically connected with the base circuit 300P and the light source 10A, so that the base circuit 300P provides electric power to the circuit member 30A for enabling the light source 10A to produce illuminating light.

It is worth mentioning that the circuit member 30A comprises an input end 31A and an output end 32A, wherein the input end 31A is electrically connected to the base circuit 300P and the output end 32A is electrically connected to the light source 10A. In other words, during the installation of the lighting apparatus, the light source 10A is electrically connected to the base circuit 300P through the circuit member 30A.

More particularly, the circuit member 30A comprises a plurality of circuit terminals electrically connected to the base circuit 300P of the mounting base 100P and the light source 10A respectively. For example, during the replacement process of the fluorescent lamps, the circuit connected with the ballast is directly connected to the circuit terminals, so that the base circuit 300P is able to provide electric power to the light source 10A without the need of modifying the circuit of the original fluorescent lamps.

Correspondingly, the light source 10A comprises a power terminal 11A electrically connected to the circuit member 30A. In other words, during the installation of the lighting apparatus, the base circuit 300P is electrically connected to the input end 31A of the circuit member 30A, and the power terminal 11A of the light source 10A is electrically connected to the output end 32A of the circuit member 30A, so that while the lighting apparatus is mounted on the mounting base 100P, the light source 10A can perform normal illumination function.

It is worth mentioning that the light source 10A of the present invention is preferred to include LED lights, so as to achieve the objective of the replacement of the current fluorescent lamps while saving electric power.

It is worth mentioning that the main frame 21A of the fixing device 20A can be a grid member for enhancing the illuminating intensity of the light source 10A and the utilization of the light source 10A. The light source 10A is designed as strip shape according to the grid shape of the main frame 21A, so that the lighting apparatus of the present invention is a LED grid lamp. In the other words, a supporting platform 211A is provided on the grid member 200P for the existing fluorescent lamps so as to enable the light source 10A to be installed on the grid member 200P.

It is worth mentioning that the grid member 200P of the current fluorescent lamps can be used as a part to produce the lighting apparatus of the present invention during the producing process of the lighting apparatus, so as to enhance the utilization of the resource and reduce the waste of the resource.

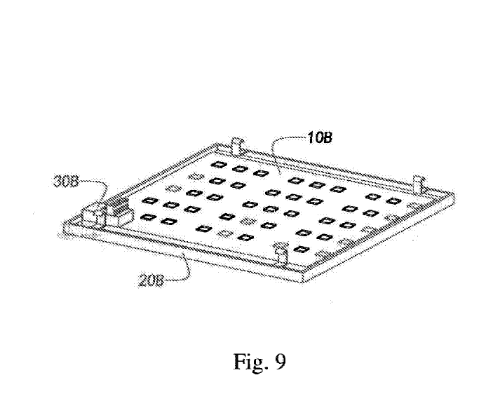

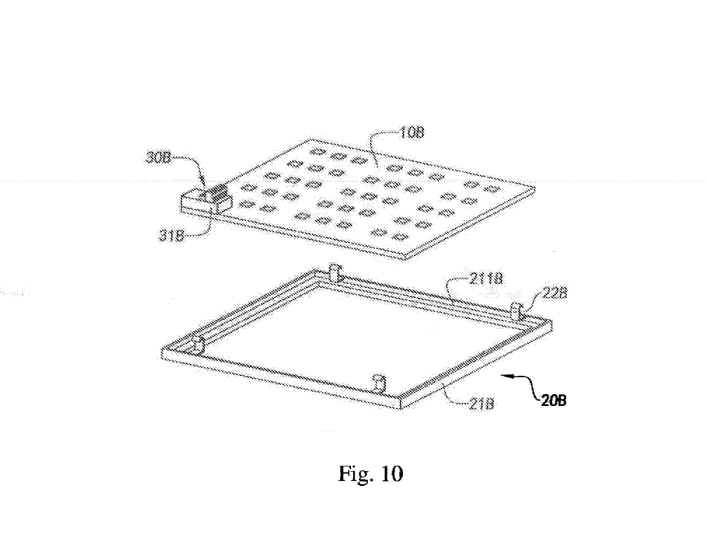

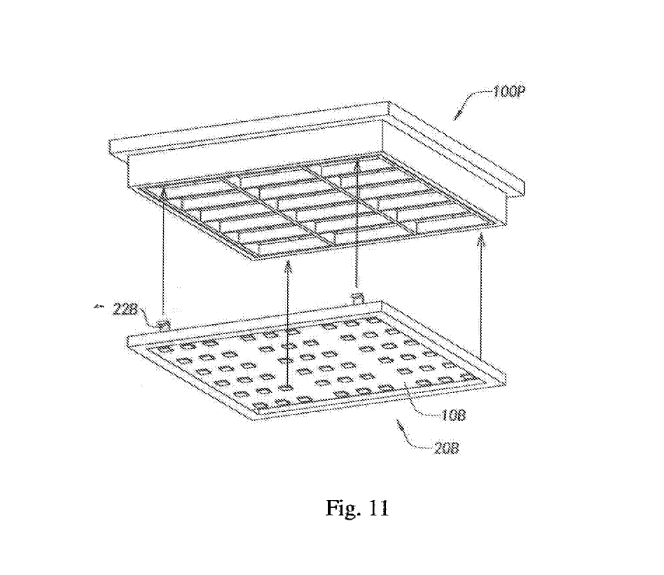

Referring to FIG. 9 and FIG. 10 of the drawings, a lighting apparatus according to a third preferred embodiment of the present invention is illustrated. The lighting apparatus is adapted to be installed on the grid member 200P of the mounting base 100P for the current fluorescent lamps. The lighting apparatus comprises a light source 10B and a fixing device 20B, wherein the light source 10B is mounted on the fixing device 20B.

It is worth mentioning that the lighting apparatus is compatible with the grid member 200P of the mounting base 100P for the current fluorescent lamps, so that the lighting apparatus is not only able to be installed on the grid member 200P, but also to install on a position underneath the mounting base 100P, so that the overall visual effect of the lighting apparatus will not be adversely affected.

It is worth mentioning that the lighting apparatus is able to directly install on the grid member 200P for the current fluorescent lamps. In other words, when the lighting apparatus is used to replace the current fluorescent lamps, the grid member 200P does not require to be disassembled, so as to facilitate the lighting apparatus to be installed on the mounting base 100P.

The fixing device 20B comprises at least one main frame 21B and at least one connecting member 22B arranged on the main frame 21B, wherein the light source 10B is fixedly arranged on the main frame 21B. The frame connecting member 22B is adapted to be connected with the grid member 200P for the current fluorescent lamp, so that the lighting apparatus of the present invention can be directly installed on the position below the current mounting base 100P. In other words, the fluorescent lamps can be replaced by the lighting apparatus of the present invention.

The main frame 21B comprises a supporting platform 211B inwardly extended therefrom and adapted for installing the light source 10B. In other words, the light source 10B is installed on the supporting platform 211B of the main frame 21B. It is worth mentioning that the light source 10B is downwardly installed on the supporting platform 211B, so that while the lighting apparatus is mounted on the grid member 200P, an illumination face of the lighting source 10B faces downwards.

Furthermore, the frame connecting member 22B is a hanger which is adapted to hang the grid member 200P with the fluorescent lamp. In other words, the lighting apparatus is hanged on a bottom portion of the grid member 200P, so that the lighting apparatus is able to be mounted on the mounting base 100P through the grid member 200P, so as to replace the current fluorescent lamps.

Furthermore, the frame connecting member 22P comprises at least four hangers, which are located on positions adjacent to four corners of the main frame 21B respectively, so that the lighting apparatus can be stably mounted on the grid member 200P.

The lighting apparatus further comprises a circuit member 30B provided on the light source 10B. The circuit member 30B is electrically connected with the base circuit 300P of the mounting base 100P, and the base circuit 300P of the mounting base 100P is able to provide electric power to the circuit member 30B, so as to provide electric power to the light source 10B for illumination by the light source 10B.

It is worth mentioning that, the circuit member 30B comprises an input end 31B electrically connected to the base circuit 300P. In other words, during the installation of the lighting apparatus, the light source 10B is electrically connected to the base circuit 300P through the circuit member 30B.

More particularly, the circuit member 30B comprises a plurality of circuit terminals electrically connected to the base circuit 300P of the mounting base 100P and the light source 10B respectively. For example, during the replacement of the fluorescent lamps, the circuit of the ballast is directly connected to the circuit terminals, so that the base circuit 300P is able to provide electric power to the light source 10B without the need to modify or reform the circuit of the original fluorescent lamps.

In other words, during the installation of the lighting apparatus, the lighting apparatus is simply hanged below the grid member 200P for the current fluorescent lamps, and the input end 31A of the circuit member 30A is electrically connected to the base circuit 300P to provide electric power by the base circuit 300P, so that while the lighting apparatus is mounted on the mounting base 100P, the light source 10B can perform normal illumination function.

It is worth mentioning that the light source 10B of the present invention includes LED lights for replacing the fluorescent lamp to save electric power.

It is worth to mention that the shape of the frame connecting member 22B of the fixing device 20B is compatible with that of the grid member 200P, so that the lighting apparatus can be installed on the grid member 200P. Therefore, person who skilled in the art should understand that the shape of the frame connecting members 22B is not limited to the hanger as shown in the drawings. For example, the frame connecting member can be in other forms such as clipping, screwing and etc. The frame connecting members 22B and the grid member 200P are incorporated with each other according to the need of the mounting base.

It is worth mentioning that the main frame 21B of the fixing device 20B can be a grid member, which is able to enhance the illuminating intensity of the light source 10B and the utilization of the light source 10B. The light source 10B is designed as strip shape based on the grid shape of the main frame 21B, so that the lighting apparatus of the present invention is a LED grid lamp. In the other words, the grid member 200P for the current fluorescent lamp provides the supporting platform 211B for installing the light source 10B thereon.

It is worth mentioning that the grid member 200P for the current fluorescent lamp can be used as a component of the lighting apparatus of the present invention during the producing process of the lighting apparatus, so that the material of the grid member 200P is utilized to enhance the utilization of resource and reduce the waste of resource.

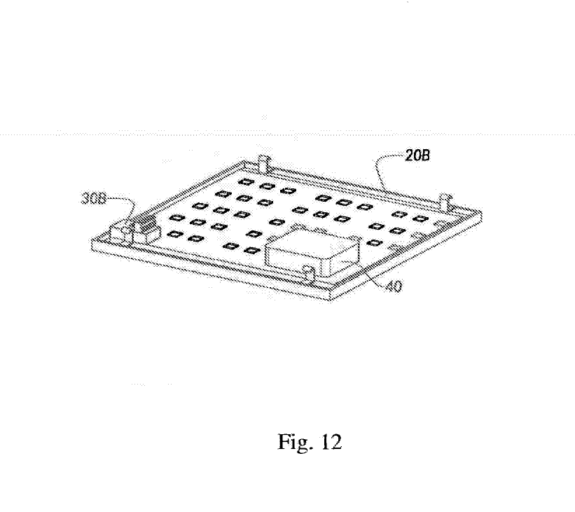

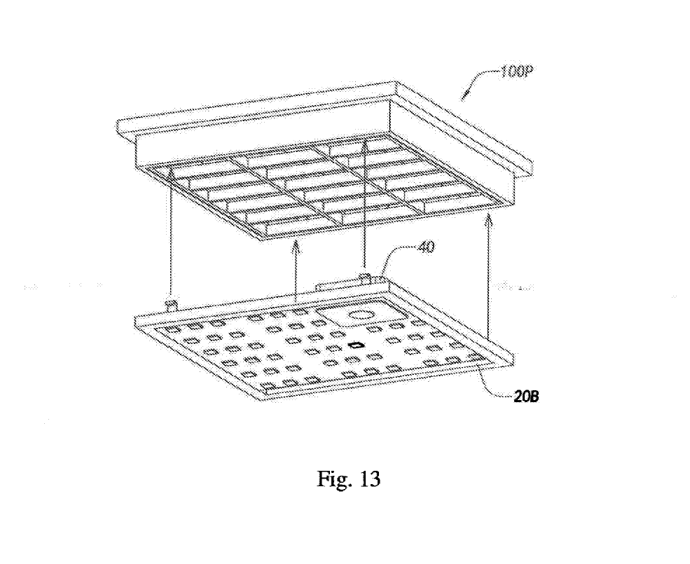

Referring to FIG. 12 and FIG. 13 of the drawings, a replacement device according to a fourth preferred embodiment of the present invention is illustrated. The replacement device is adapted for simply replacing the conventional lamps, especially the traditional fluorescent lamps. The mounting base 100P, the grid member 200P, and the base circuit 300P of the current fluorescent lamps are used by the replacement device of the present invention, so that it is unnecessary to remodel or modify the mounting base 100P, the grid member 200P, and the base circuit 300P. Also, an installation position is provided for the replacement device, such as the position for hanging on the current fluorescent lamps, so as to largely save placing space and provide convenience to human life.

The different between the above mentioned first to third embodiment with this fourth embodiment is that the replacement device comprises a replacing member 40, a circuit member 30B, and a fixing device 20B, wherein the replacing member 40 which is installed on the fixing device 20B is provided with installing and fixing positions by the fixing device 20B. The replacing member 40 is electrically connected to the circuit member 30B to obtain the electric power from the circuit member 30B.

According to this preferred embodiment of the present invention, the replacing member 40 of the replacement device is embodied as a projecting member. In other words, the replacing member 40 is able to perform as a projector, for example connecting with a computer, to project on a predetermined location. In the traditional manner, the projector is required to install on a ceiling through an independent frame, wherein the installation of the independent frame and the electric wiring are relatively complicated. Also, in some situation, there is no independent frame pre-installed on the ceiling, and thus the projector has to place on a table, such that the projecting angle of the projector is difficult to adjust, certain surface position of the table is occupied by the projector, and the projector is required to electrically connect to power source. Therefore, no matter the projector is installed on the ceiling or placed on the table, there are inconvenient factors for the user. According to the present invention, the replacing member 40B provides the projecting function, and the replacement device is able to be mounted on the mounting base 100P through the fixing device 20B, so that no independent frame is required and the replacing member 40 can be electrically connected with the circuit member such that no additional electric wiring is required, so as to save more installing space while it is easier to install.

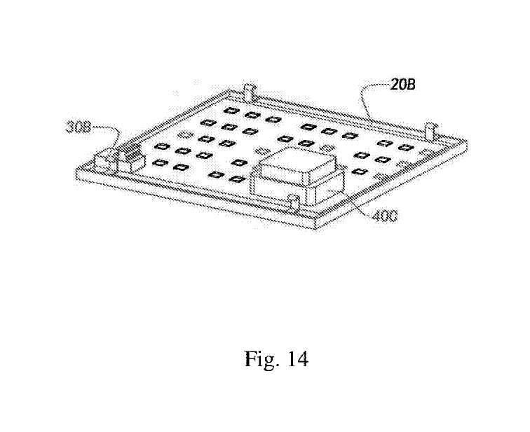

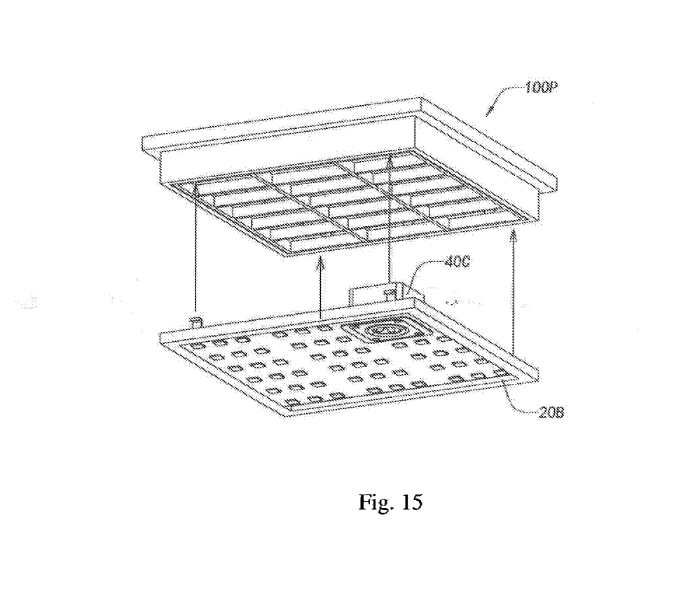

Referring to FIG. 14 and FIG. 15 of the drawings, a replacement device according to a fifth preferred embodiment of the present invention is illustrated, the replacement device is adapted to simply replace the conventional lamp, especially the traditional fluorescent lamps. The mounting base 100P, the grid member 200P, and the base circuit 300P of the current fluorescent lamps are used by the replacement device of the present invention, so that it is unnecessary to modify or reconstruct the mounting base 100P, the grid member 200P and the base circuit 300P, and that an installation position is provided by the replacement device, such as the position for hanging the current fluorescent lamp, so as to save placing and installing spaces and provide us more convenience.

A different between the above mentioned first to fourth embodiment with this fifth embodiment is that the replacement device comprises a replacing member 40C, a circuit member 30B and a fixing device 20B, wherein the replacing member 40C is installed on the fixing device 20B, wherein an installing and fixing position for the replacing member 40C is provided by means of the fixing device 20B. The replacing member 40C is electrically connected to the circuit member 30B to obtain the electric power from the circuit member 30B.

According to this preferred embodiment of the present invention, the replacing device 40C is embodied as an audio device. In other words, the replacing device 40C is capable of playing music and etc. In other words, the replacing member 40C is mounted on the mounting base 100P through the fixing device 20B, and the electric power is provided by the circuit member 30B to support the replacing member 40C to broadcast.

Especially, the replacing member 40C can be connected to the sound transmitting and controlling device, such as mobile phone, in a wiring or wireless manner, so that the music saved in the mobile phone can be played through the replacing member 40C.

In the traditional manner, the audio device is directly place on the ground, table or etc., that substantially occupies certain space and position. Other audio device is mounted on wall though fixing members for producing stereo and surround sound in space. The above mentioned installing and placing method for the traditional audio device has still to occupy space in room and its installation process is complicated too.

According to the fifth preferred embodiment of the present invention, the replacing member 40 of the replacement device provides the audio device function, so that the replacement device is able to be simply installed on the mounting base 100P through the fixing device 20B while no independent fixing member is required. The replacing member 40 can be electrically connected to the circuit member, so that no additional electric wiring is required and installing space for the lighting apparatus is saved. When a broadcasting surface of the replacing member 40C faces downwards, better sound effect is provided in the entire room. For example, if the replacing member 40C is arranged in a center portion of the room, a symmetric sound field is generated by the replacing member 40C so as to provide a better sound effect.

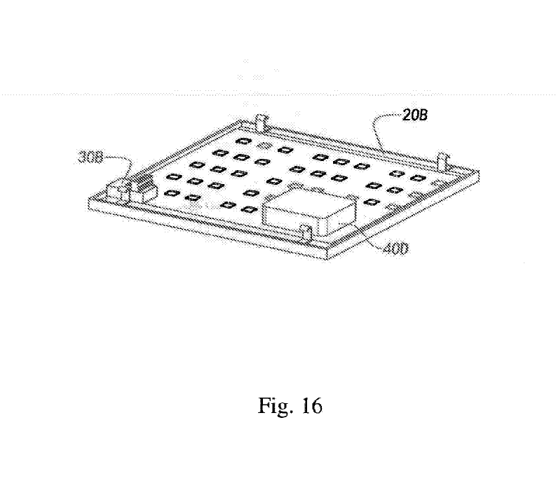

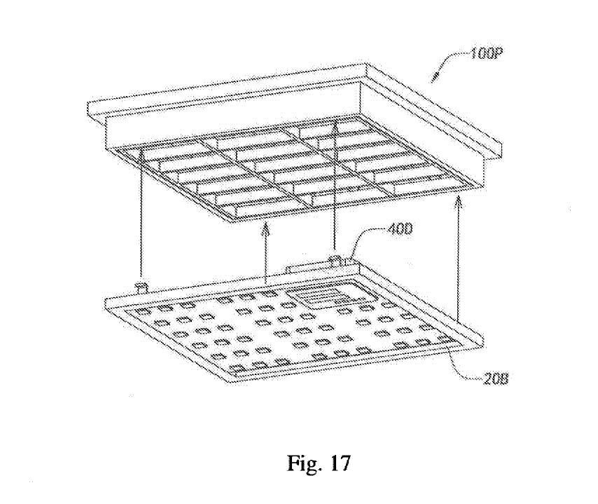

Referring to FIG. 16 and FIG. 17 of the drawings, a replacement device according to a sixth preferred embodiment of the present invention is illustrated. the replacement device is adapted to simply replace the conventional lamp, especially the traditional fluorescent lamp. The mounting base 100P, the grid member 200P and the base circuit 300P of the current fluorescent lamps are used by the replacement device of the present invention, so that it is unnecessary to modify or reconstruct the mounting base 100P, the grid member 200P and the base circuit 300P. An installation position is provided by the replacement device, such as a position for hanging the current fluorescent lamp, so as to save placing spaces and provide us more convenience.

A different between the above mentioned first to fifth embodiment with this sixth embodiment is that the replacement device comprises a replacing member 40D, a circuit member 30B and a fixing device 20B, wherein the replacing member 40D is installed on the fixing device 20B and a installing and fixing position for the conventional lamp is provided by the fixing device 20B, while the replacing member 40D is electrically connected to the circuit member 30B to obtain the electric power from the circuit member 30B.

According to this preferred embodiment of the present invention, the replacing member 40D is embodied as an intelligent control member. In other words, the replacing member 40D is able to process intelligent controlling, such as controlling various external instruments provided in a room, and is communicated with a computer, mobile phone, or etc. The various external instruments are able to transmit and control information, such as playing the videos. For example, while the replacement device is installed on the ceiling of a bedroom, the user is able to watch videos on the bed.

Intelligent instruments are widely used in our daily life, such as intelligent furniture, so that the replacement device, embodied as a control member, is not only installed at the existing installation position, but also is able to use the current circuit without the need of any additional electric wiring so as to save installing and placing space and provide us more convenience.

Person skilled in the art should understand that the replacement device is not limited by the above embodied projector, audio device and intelligent control member, wherein the replacement device can also be an air purifier, or that the replacement device is able to combine with the light source 10, so that the lighting apparatus not only can provide illumination function, but also can provide functions of projecting, playing music and videos, and intelligent controlling.

It is worth mentioning that the fixing device 20B and the circuit member 30B are able to be replaced by the fixing device 20A, 20, and circuit member 30A, 30 of the above mentioned embodiments, and the replacing members 40, 40C, 40D are able to be installed on stable positions. It is worth mentioning that the structure of the fixing device 20B is not limited by the above embodiments of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A lighting apparatus, adapted to be installed on a current mounting base, for one or more current fluorescent lamps, having a base circuit and a grid member, comprising:
a light source; and
a fixing device;
wherein said light source is installed on said fixing device, and said fixing device is compatible with the current mounting base, so that said light source is compatible to be mounted on the current mounting base.

2. The lighting apparatus, as recited in claim 1, wherein said fixing device comprises a main frame and said light source having an illumination surface facing downwards is installed on said main frame.

3. The lighting apparatus, as recited in claim 2, wherein said fixing device comprises at least one frame connecting member provided on said main frame, wherein said frame connecting member is matched with a base connecting member of said current mounting base, so that said main frame is able be supported in said current mounting base.

4. The lighting apparatus, as recited in claim 3, wherein said frame connecting member comprises a connecting groove matched with a connecting arm of said current base connecting member, wherein said connecting arm is able to be inserted into said connecting groove.

5. The lighting apparatus, as recited in claim 4, wherein said fixing device comprises four frame connecting members, which are positioned adjacent to four corners of said main frame respectively, corresponding with said connecting arms of said base connecting members respectively.

6. The lighting apparatus, as recited in claim 3, further comprising a circuit member electrically connected with said light source.

7. The lighting apparatus, as recited in claim 6, wherein said light source includes one or more LED lights.

8. The lighting apparatus, as recited in claim 6, wherein said fixing device is a grid member.

9. The lighting apparatus, as recited in claim 6, wherein said circuit member is provided in said light source.

10. The lighting apparatus, as recited in claim 9, wherein said circuit member comprises an input end having a plurality of terminal terminals electrically connected to said base circuit.

11. The lighting apparatus, as recited in claim 9, wherein said circuit member comprises an input end and an output end, wherein said input end is electrically connected to said base circuit and said output end is electrically connected to said light source.

12. The lighting apparatus, as recited in claim 11, wherein said circuit member is provided on said fixing device.

13. The lighting apparatus, as recited in claim 12, wherein said fixing device comprises a frame connecting member adapted to be connected with a bottom portion of said grid member.

14. The lighting apparatus, as recited in claim 13, wherein said frame connecting member is a hanging member adapted to be hanged on the bottom portion of said grid member.

15. The lighting apparatus, as recited in claim 14, wherein said hanging member is a hanger provided adjacent to four corners of said main frame respectively.

16. The lighting apparatus, as recited in claim 13, wherein said frame connecting members comprises four hanging members positioned adjacent to four corners of said main frame respectively.

17. A replacement device, adapted to be installed on a current mounting base, for one or more current fluorescent lamps, having a base circuit and a grid member, comprising:
a replacing member; and
a fixing device;
wherein said replacing member is adapted to be installed on said fixing device which is matched with said current mounting base, wherein a light source is installed on said current mounting base.

18. The replacement device, as recited in claim 17, wherein said fixing device comprises a main frame and said replacing member is provided on said main frame to provide a position for said replacing member.

19. The replacement device, as recited in claim 18, wherein said fixing device comprises at least one frame connecting member installed on said main frame, wherein said frame connecting members are compatible with a base connecting member of said current mounting base, so that said main frame is able to be supported on said current mounting base.

20. The replacement device, as recited in claim 19, wherein said frame connecting member comprises a connecting groove which is matched with a connecting arm of said base connecting member, wherein said connecting arm is able to be inserted into said connecting groove.

21. The replacement device, as recited in claim 20, wherein said fixing device comprises four frame connecting members provided adjacent to four corners of said main frame respectively and matched with said connecting arm of said four base connecting members respectively.

22. The replacement device, as recited in claim 19, further comprising a circuit member electrically connected to said replacing member.

23. The replacement device, as recited in claim 22, wherein said replacing member is a projecting member which is electrically connected to said circuit member to perform projecting function.

24. The replacement device, as recited in claim 22, wherein said replacing member is an audio device electrically connected to said circuit member for broadcasting.

25. The replacement device, as recited in claim 22, wherein said replacing member is an intelligent control member electrically connected to said circuit member to communicate with external instruments to transmit and control intelligent information.
